(19) United States
(12) Patent Application Publication
(10) Pub. No.: US 2012/0258278 A1
(43) Pub. Date: Oct. 11, 2012

(54) Waterproof, weather resistant tiled table

(76) Inventor: George Upham, Germantown, NY (US)

(21) Appl. No.: 13/066,083

(22) Filed: Apr. 6, 2011

(51) Int. Cl. B32B 3/12; B32B 37/18; B32B 37/12

(52) U.S. Cl. 428/116; 156/297

(57) ABSTRACT

A tabletop includes a honeycomb panel including a honeycomb core attached to a top and bottom skin. The top surface of the top skin is decorated with tiles adhered to the panel and waterproofed with a hydrophobic, flexible silicone sealer/adhesive. The sealer/adhesive provides moisture resistance and compensation for the differences in the coefficient of thermal expansion of the honeycomb panel and the tiles adhered to the panel. The honeycomb panel may be a metal, preferably aluminum.

### BACKGROUND OF THE INVENTION

1. Field of the Invention

The present invention relates generally to furniture items. More particularly, the invention relates to a tiled furniture item. Even more particularly, this invention relates to tiled tables able to withstand extreme weather conditions including high humidity, wide variations in temperature, and severe weather without sustaining damage to the tiles or the table.

2. Description of Related Art

It is extremely important that a tiled table used outdoors be impervious to water as well as wide variations in temperature. Water and humidity can weaken the adhesion of the tiles to the substrate and thermal expansion and contraction of the tiled surface can cause fissuring and even breakage of the tiles or shearing the adhesive causing the tiles to separate from the table. Tiled tables currently on the market of the type described here are not adequately protected for outdoor use or other humid or freezing environments such as a northern winter of North America in an unheated house, in a greenhouse, on a patio or porch, or in a yard or garden etc. The more reputable manufacturers of most currently available tiled tables specifically state that their tables should not be placed outdoors or in an uncontrolled atmosphere. Some tiled tables may be placed outdoors, for example, cast aluminum tables. The choice of tiles for these tables is generally very limited, including mostly plain colored “field” tiles, stone tiles, or pre-manufactured mosaic tile sheets, which have nothing like the beauty and quality of decorated ceramic or porcelain tiles.

The principal structural elements and substrates for the tiles of currently available tiled tables generally are wood, concrete, or various cement-based products or panels. The wood may be an engineered composite particleboard or plywood. These materials present many problems, since neither wood products nor cement-based products are by themselves impermeable to humidity or other moisture. If this moisture is accompanied by extreme changes in temperature, such as freezing weather, the consequent expansion and contraction may cause the tiles to separate from the substrate or fissure, or break. Moreover, with these and similar materials, both the tiled top and the exposed bottom of the table top may be harmed by moisture reaching the tiled surface. In order to be protected from moisture, these materials must be treated with a waterproofing product. However, these waterproofing products are effective only for a limited duration and must be reapplied at regular intervals, posing a bothersome responsibility on the user. Many of the products sold for waterproofing the surfaces of tables are undependable and the user is generally not equipped to know which to use. Furthermore, in order to assure sufficient rigidity to prevent the tiled surface from flexing and consequently fissuring or breaking the tile, a wood panel substrate must be very thick or reinforced, which makes it very heavy. A concrete or other cement-based substrate for tiles is by its very nature extremely heavy. This means that typical tiled tables are heavy, and for larger tiled tables will require several persons to move them. In commercial use, moving these tables, for example from indoors to outdoors in restaurants or hotels, to clean the floor or at closing etc., is difficult due to their weight. Furthermore, due to their weight, shipping charges for such tables are very expensive for standard tiled tables and much greater for a given table size. This results in a significant additional cost for the purchaser.

Tile is almost universally set and adhered to a substrate with a cement and sand based product commonly referred to as “thinset” or with an epoxy cement. All cement based materials except epoxy cement absorb humidity and, if frozen, will expand and will cause damage to the substrate and the tiles. The principal exceptions are, for example, when the tiles are set in a thick and generally reinforced concrete, as with swimming pools and similar applications. Epoxy adhesives are water and humidity proof. However, these adhesives are not flexible, which means they do not adjust for the difference in the coefficients of thermal expansion of the tiles, the substrate, and the grouting between the tiles. Therefore, a tiled table cannot use epoxy adhesives if exposed to significant changes in ambient temperature, such as in freezing or extremely hot weather, as the inflexibility of the epoxy adhesive may cause the tile to separate from the substrate or fissure or crack.

Grout is almost universally used to fill the spaces between the tiles. However, the cement based grout which is almost exclusively used for this purpose is not impervious to humidity and is not flexible. Tile damage will occur if the table is subjected to thermal expansion and contraction, especially in extreme hot or cold temperatures. Furthermore, cement-based materials can absorb humidity and, if frozen, will expand thus causing damage to the tiles. The grout itself may also crack or crumble if exposed to moisture, extreme temperature changes or flexing. Furthermore, efflorescence may be experienced when using cement based grout. Efflorescence causes a powdery accumulation on the surface of the grout that must be cleaned. Epoxy cement grout is also sometimes used. Epoxy cement is waterproof; but it is not flexible and therefore will not allow for expansion and contraction of the tiled surface. The inflexibility of epoxy cement grout is a very important disadvantage of many tiled tables currently available.

Currently honeycomb aluminum panels have been used to create lightweight tables. One particular example is a table with a wood veneer attached to the top of a honeycomb aluminum panel as a surface decoration. Other examples include tables using bare honeycomb aluminum panels with no decorative coverings, used because they are very flat and rigid. Some examples of the use of these panels are called Clean Room tables and Glass Conference tables and as structural parts of furniture. Furthermore, the impermeability to moisture of honeycomb aluminum is not mentioned as a characteristic or quality in these examples because it is of no importance for their customers. Cast and other types of aluminum tables are also manufactured which do not use honeycomb aluminum panels. They are rigid, relatively light in weight and impervious to water; however, these are a totally different type of table and use only a very limited type and selection of tile, generally stone tile or pre-manufactured mosaic sheet. They are rather cheap in appearance.

U.S. Pat. No. 4,822,661 (Battaglia) describes panels with a thin layer of stone backed by a sheet of lightweight backing material, for example, an aluminum honeycomb backing. The stone layer and the honeycombed backing are bonded together by an epoxy adhesive which, as specified above, is not flexible. The honeycomb panel of Battaglia has no skin and the stone is directly adhered to the honeycomb panel. This results in the adhesive having a very minimum area for adhesion. Furthermore, the fact that the honeycomb has no skin means that there is no barrier to the penetration of humidity from below the panel. This is an important requirement for a table subject to significant environmental changes, particularly to freezing weather in the presence of any humidity or water.

### SUMMARY OF THE INVENTION

An objective of this invention to provide a tiled furniture item, such as a tiled table, in which the tiles are adhered to the furniture item and are impervious to moisture.

Another object of the this invention is to provide a tiled furniture item, such as a tiled table, that compensates for the differences in the coefficients of thermal expansion of the substrate and the tiled surface of the furniture item, such that the tiled table, is capable of withstanding extreme temperature changes without damage.

Further, another object of this invention is to provide a tiled furniture item, such as a tiled table, that is relatively light in weight.

To accomplish at least one of these objects, a tiled table furniture item has a tabletop furniture element that includes a light weight honeycomb panel with a skin, and a plurality of tiles. The honeycomb panel has a solid top plate or skin, a solid bottom plate or skin, and a honeycomb core adhered to the top skin and the bottom skin. The tiles are adhered to the honeycomb panel and grouted with a hydrophobic, flexible sealer/adhesive. The sealer/adhesive provides sufficient flexibility to compensate for the differences of the coefficient of temperature expansions of the honeycomb panel, the individual tiles, adhered to the honeycomb panel.

In various embodiments, the light weight honeycombed panel is a metal such as aluminum, steel, or copper. In most embodiments, the sealer/adhesive is a silicone sealer/adhesive. In other embodiments, the sealer/adhesive is a polyurethane sealer adhesive.

In various embodiments, the tiles are ceramic or porcelain tiles. In other embodiments, the tiles are various other materials such as stone tiles. In some embodiments, the tiles applied to the surface of the honeycomb panel have border tiles applied to edges of the honeycomb panel that are adhered to the honeycomb panel with the hydrophobic, flexible sealer/adhesive. In all embodiments, the hydrophobic, flexible sealer/adhesive is applied as a grouting material between the tiles as adhered to the honeycomb panel.

### BRIEF DESCRIPTION OF THE DRAWINGS

FIG. 1 is a isometric drawing of a cross-section of various embodiments of a tiled tabletop.

FIG. 2 is a isometric drawing of a cross-section of various embodiments of a tiled table.

### DETAILED DESCRIPTION OF THE INVENTION

In various embodiments a tabletop furniture element includes a light weight honeycomb panel having a honeycombed core attached to a solid top plate or skin and a solid bottom plate or skin. The top surface of the top skin is decorated with tiles adhered to the panel through the use of a flexible, hydrophobic silicone sealer/adhesive. The flexible, hydrophobic sealer/adhesive is used as a grouting between the tiles. The sealer/adhesive provides total moisture resistance and as a consequence of its flexibility even at extreme temperatures, compensates for the differences in the coefficient of thermal expansion of the honeycomb panel and the entire top layer of tiles adhered to the panel as well as between the individual tiles. In most embodiments, the honeycomb panel with the honeycombed core and the solid top and bottom skins are metal, preferably aluminum, but may be any metals such as steel or copper.

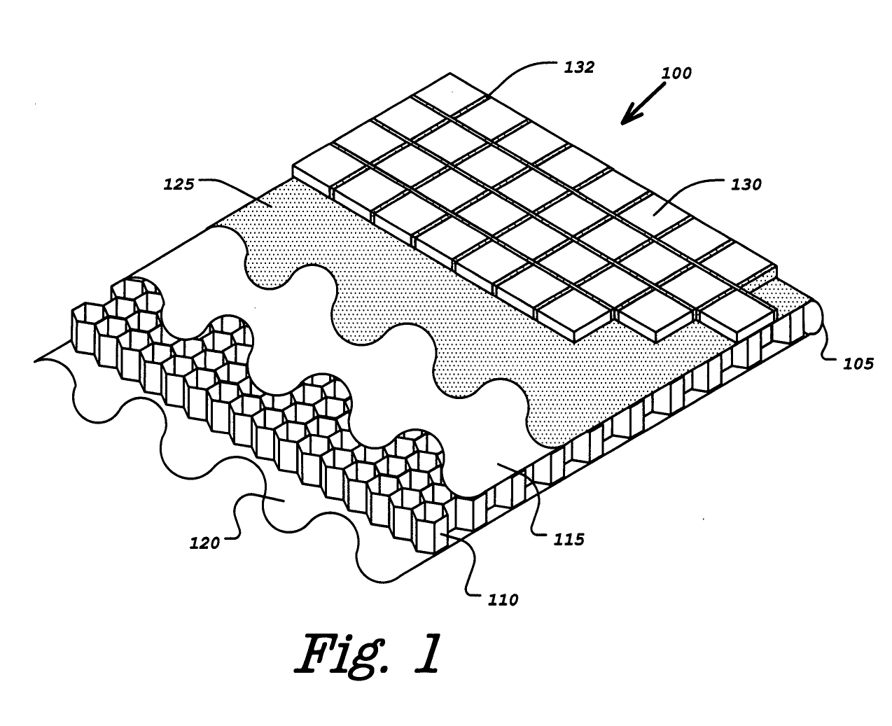

FIG. 1 is a cross sectional view of an embodiment of a tabletop 100 comprising a light weight honeycomb panel 105. In most embodiments, the honeycomb panel 105 is a light weight metal such as aluminum. The honeycomb panel 105 has a bottom substrate surface or skin 110 formed of a solid sheet of the metal. A metal honeycomb core structure 115 is secured to the solid bottom substrate or skin 110. A solid top substrate or skin 120 is secured to the honeycomb core structure 115. The honeycomb panel 105 is commercially available from numerous suppliers. The commercially obtainable honeycomb panels 105 are offered with a variety of panel thicknesses, differing cell sizes of the honeycomb core structure 115, and in multiple gauges for the bottom substrate or skin 110 and the top substrate or skin 120. Further in other embodiments, the honeycomb panel 105 is manufactured of materials that provide light weight and high resistance to moisture and temperature extremes. A metal honeycomb panel 105 is also the most resistant to flexion of any lightweight material. The lightest weight commonly used metal is aluminum. Therefore in the most embodiments, the honeycomb panel 105 with the honeycombed core structure 115 and the solid skins 110 and 115 is aluminum and acts as a primary table part and is a substrate for the tiles 130. The use of honeycomb aluminum panel 105 with metal skins 110 and 120 prevents any humidity from penetrating from the underside of the tabletop 100 as the honeycomb aluminum panel 105 is impervious to humidity.

The top surface 120 of the honeycomb aluminum panel 105 is decorated with tiles 130. In various embodiments, the tiles 130 are ceramic or porcelain tiles. In other embodiments the tiles 130 are stone tiles, glass tiles, metal tiles, glass marbles, pebbles, etc. In some embodiments, the tiles are wooden panels which have special treatment to make the wood impervious to water and weather extremes. The tiles 130 are bonded to the top surface of the top skin 120 of the honeycomb aluminum panel 105 with a flexible, hydrophobic (waterproof) sealer/adhesive 125 such as silicone.

The flexible, hydrophobic sealer/adhesive 125 such as a silicone sealer/adhesive is chosen for its ability to isolate tiles 130 from humidity, water or other liquids. The thermal coefficient of linear expansion for aluminum is approximately 12.3/° F. (22.2/° C.) and the thermal coefficient of linear expansion for ceramic tile is approximately 4.9/° F. (8.9/° C.). It is apparent that the differences in the expansion and contraction rates of the honeycomb aluminum panel 105 and the ceramic tile may cause a cement based grout or an epoxy cement which are very rigid to cause fissures or cracks in the tiled surface with the expansion and contraction due to changes in ambient temperature. The flexible, hydrophobic sealer/adhesive 125 used both to adhere the tiles to the substrate and as a filler between the tiles retains its plasticity over a wide range of temperatures from very low temperatures to very high temperatures. This flexibility compensates for the differences in the expansion between the honeycomb aluminum panel 105 and the tiles and that of the entire tiled surface 130 to prevent shearing of the bond between the honeycomb aluminum panel 105 and the tiles 130. Further, the hydrophobic qualities of the silicone sealer/adhesive 125 prevent moisture from entering or mixing with the silicone sealer/adhesive 125 making it waterproof. The flexibility of the silicone sealer/adhesive prevents stress between the tiles 130 and the silicone sealer/adhesive 125. Additionally, the honeycomb aluminum panel 105 is impervious to liquid water or water vapor and other moisture from above and from below the table top and protects the entire ensemble from humidity in the external environment.

In some embodiments, the tabletop 100 may include a border (not shown). The border may provide a decorative, protective feature that must be impervious to water and resistant to water and weather extremes. The border may be ceramic, porcelain, stone, metal, or other suitable material. In other embodiments the border may be wood suitably treated for outdoor use to make it impervious to water and resistant to weather extremes. In various embodiments the table top 100 may have no border in which case, the tiles 130 along the outer edges of the tabletop 100 are “bullnosed” that is rounded on the outer edges of the table. In all of these embodiments, the tiles and the bull-nosed border is are adhered to honeycomb aluminum panel 105 using the silicone sealer/adhesive 125.

The spaces between tiles 130 are sealed with the flexible, hydrophobic sealer/adhesive 125. It is essential to completely fill the voids 132 between tiles 130 in order to create an entirely waterproof surface composed of the tiles 130, the border if present, and the silicone sealer/adhesive 125.

Examples of the silicone sealer/adhesive 125 are Dow Corning RTV 734 flowable sealant (White) from Dow Corning Corporation Midland Mich. 48686-0994 and Loctite Superflex 59575 silicone adhesive (clear) from Loctite® Brand, Henkel Corporation, Westlake, Ohio 44145. The silicone sealer/adhesive 125 of the aforementioned examples is white or transparent (clear). However, other colors may be available and it is within the scope of this invention that any colored silicone sealer/adhesive 125 may be used as long as the hydrophobic properties and the flexibility over the temperature range are maintained.

In some embodiments a non-silicone sealer/adhesive replaces the silicone sealer/adhesive 125 that is in keeping with the principles of this invention in that it remains flexible at low temperatures and is resistant to moisture. An example of the non-silicone sealer/adhesive 125 is a polyurethane based sealer/adhesive. However, polyurethane sealer/adhesive does not remain as flexible at low temperatures nor is as resistant to moisture as the silicone sealer/adhesive. Furthermore, the silicone sealer/adhesives are longer lasting than polyurethane sealer/adhesives, which will lose their flexibility and moisture resistance characteristics over a lesser time span than silicone sealer/adhesives. An example of the polyurethane sealer/adhesives is 3M™ Polyurethane Adhesive Sealant 550 from 3M Corporation St. Paul, Minn. 55144-1000.

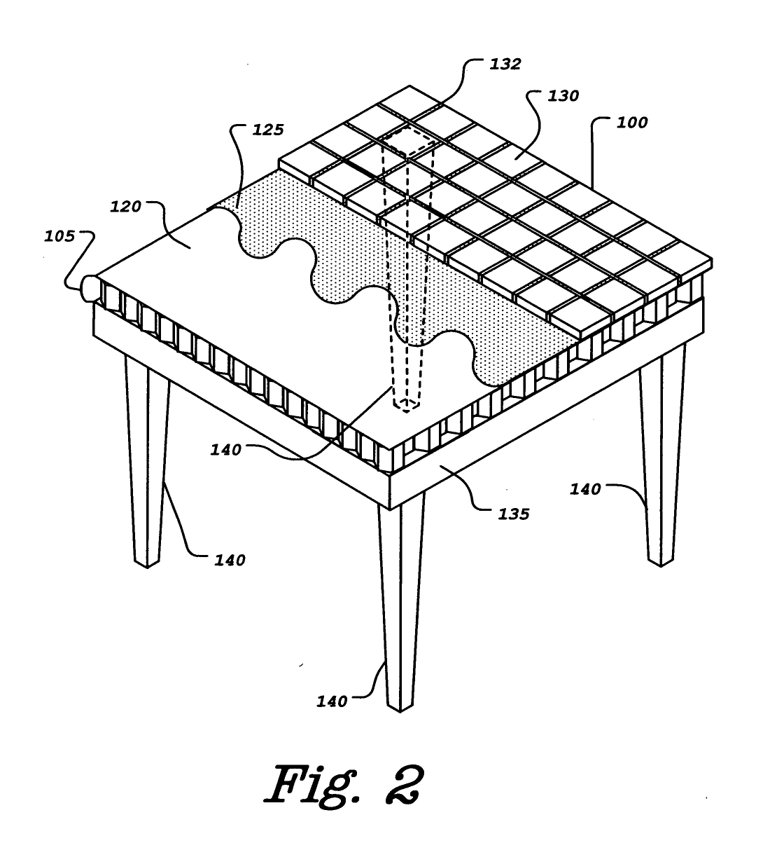

FIG. 2 is an isometric drawing of a cross-section of various embodiments of a tiled table furniture item. The tiled table includes the tabletop 100, a supporting frame 135, and four legs 140. The tabletop 100 has the tiles 130 adhered to the top surface 120 of the honeycomb aluminum panel 105 with the flexible, hydrophobic sealer/adhesive 125 as described in FIG. 1. The honeycomb aluminum panel 105 may in some embodiments be mounted to a frame 135. The frame 135, in some embodiments, is wood. In other embodiments, the frame may be a metal such as steel or aluminum. Four legs 140 are attached to the frame 135. The legs 140, in various embodiments, are wood that also has been treated to withstand moisture. In other embodiments, the four legs 140 may be a metal such as steel or aluminum. In some embodiments, the four legs, 140 are replaced with a single pedestal base or other type of metal base. Any support structure of the tabletop 100 is in keeping with the principles of this invention.

The embodiments of the tiled tabletop 100 can be left outdoors and exposed to essentially all weather conditions from extreme heat or cold to high humidity or rain, freezing rain, hail, snow etc. Further the tiled tabletop 100 may be stored indoors in extremely humid and very cold conditions, for example in storage or in an unheated house closed up for the winter, without the possibility that the tiles will fissure or fracture or detach from the substrate, or any other damage which might result from the above described weather conditions. Furthermore, the construction results in a much lighter and thinner table than other tiled tables, making it much easier to move from one place to another. In addition, due to their relatively light weight, they are much less expensive to ship.

The invention has been described above by way of illustration, and the specific embodiments disclosed are not intended to limit the invention to the particular forms disclosed. For example, the particular implementation of the tiled surface may vary depending upon the particular type of structure on which it is to be used. In other embodiments, lightweight and weather resistant tiled surfaces, as described above, are applied to various different furniture items such as benches, countertops, landscaping structures, workbenches, or other tiled surface. Non-tabletop implementations of the present invention are in keeping with the principles of the present invention.

While this invention has been particularly shown and described with reference to the various embodiments thereof, it will be understood by those skilled in the art that various changes in form and details may be made without departing from the spirit and scope of the invention.

The invention claimed is:

1. A furniture element comprising:
a honeycomb panel comprising:
a top and bottom skin; and
a honeycomb core secured between the top and bottom skins;
a plurality of tiles adhered to the honeycomb panel; and
a hydrophobic, flexible sealer/adhesive placed between the plurality of tiles and the honeycomb panel to secure the plurality of tiles to the honeycomb panel to prevent moisture from entering between the honeycomb panel and the plurality of tiles wherein the hydrophobic, flexible sealer/adhesive remains flexible and moisture resistant over an extreme range of temperature and moisture conditions.

2. The furniture element of claim 1 wherein the furniture element is a tabletop, bench top, countertop, landscaping structural surface, workbench top, or other tiled surface

3. The furniture element of claim 1 wherein the hydrophobic, flexible sealer/adhesive is a silicone sealer/adhesive.

4. The furniture element of claim 1 wherein the hydrophobic, flexible sealer/adhesive is a polyurethane sealer/adhesive.

5. The furniture element of claim 1 wherein the top and bottom skins and the honeycomb core are a metal.

6. The furniture element of claim 5 wherein the metal is aluminum, steel, or copper.

7. The furniture element of claim 1 wherein the plurality of tiles are ceramic, porcelain tiles, stone tiles, or wooden tiles.

8. The furniture element of claim 1 wherein the hydrophobic, flexible sealer/adhesive is applied as a grouting compound to completely fill all the spaces between each tile of the plurality the tiles.

9. The furniture element of claim 1 wherein the plurality of tiles includes a border element adhered to an edge the honeycomb panel with the hydrophobic, flexible sealer/adhesive.

10. A furniture item comprising
a furniture element comprising:
a honeycomb panel comprising:
a top and bottom skin, and
a honeycomb core secured between the top and bottom skins;
a plurality of tiles adhered to the honeycomb panel; and
a hydrophobic, flexible sealer/adhesive placed between the plurality of tiles and the honeycomb panel to secure the plurality of tiles to the honeycomb panel to prevent moisture from entering between the honeycomb panel and the plurality of tiles, wherein the hydrophobic, flexible sealer/adhesive remains flexible and moisture resistant over an extreme range of temperature and moisture conditions.

11. The furniture item of claim 10 wherein the furniture item is a table, bench, countertop, landscaping structure, workbench, or other tiled surface.

12. The furniture item of claim 10 wherein the hydrophobic, flexible sealer/adhesive is a silicone sealer/adhesive.

13. The furniture item of claim 10 wherein the hydrophobic, flexible sealer/adhesive is a polyurethane sealer/adhesive.

14. The furniture item of claim 10 wherein the top and bottom skins and the honeycomb core are a metal.

15. The furniture item of claim 14 wherein the metal is aluminum, steel, or copper.

16. The furniture item of claim 10 wherein the plurality of tiles are ceramic, porcelain tiles, stone tiles, or wooden tiles.

17. The furniture item of claim 10 wherein the hydrophobic, flexible sealer/adhesive is applied as a grouting compound to completely fill all the spaces between each tile of the plurality the tiles.

18. The furniture item of claim 10 wherein the plurality of tiles includes a border element adhered to an edge the honeycomb panel with the hydrophobic, flexible sealer/adhesive.

19. A method of constructing a furniture element comprising:
providing a honeycomb panel comprising:
a top and bottom skin; and
a honeycomb core secured between the top and bottom skins; and
adhering a plurality of tiles to the honeycomb panel;
wherein adhering the plurality of tiles to the honeycomb panel comprises: applying a hydrophobic, flexible sealer/adhesive placed between the plurality of tiles and the honeycomb panel to secure the plurality of tiles to the honeycomb panel to prevent moisture from entering between the honeycomb panel and the plurality of tiles, wherein the hydrophobic, flexible sealer/adhesive remains flexible and moisture resistant over an extreme range of temperature and moisture conditions.

20. The method of constructing a furniture element of claim 19 wherein the furniture element is a tabletop, bench top, countertop, landscaping structural surface, workbench top, or other tiled surface

21. The method of constructing a furniture element of claim 19 wherein the hydrophobic, flexible sealer/adhesive is a silicone sealer/adhesive.

22. The method of constructing a furniture element of claim 19 wherein the hydrophobic, flexible sealer/adhesive is a polyurethane sealer/adhesive.

23. The method of constructing a furniture element of claim 19 wherein the top and bottom skins and the honeycomb core are a metal.

24. The method of constructing a furniture element of claim 23 wherein the metal is aluminum, steel, or copper.

25. The method of constructing a furniture element of claim 19 wherein the plurality of tiles are ceramic tiles, porcelain tiles, stone tiles, or wooden tiles.

26. The method of constructing a furniture element of claim 19 further comprising applying the hydrophobic, flexible sealer/adhesive as a grouting compound to completely fill all the spaces between each tile of the plurality the tiles.

27. The method of constructing a furniture element of claim 19 wherein the plurality of tiles includes a border element adhered to an edge the honeycomb panel with the hydrophobic, flexible sealer/adhesive.
